(19) United States
(12) Patent Application Publication
(10) Pub. No.: US 2003/0065946 A1
(43) Pub. Date: Apr. 3, 2003

(54) Paragraph management software system

(76) Inventor: John F. Holliday, Atlanta, GA (US)

Correspondence Address: JOHN F. HOLLIDAY, 1401 TUGALOO DRIVE, ATLANTA, GA, 30319, US

(21) Appl. No.: 09/968,068

(22) Filed: Oct. 1, 2001

(51) Int. Cl. H04L 9/00

(52) U.S. Cl. 713/201; 705/52

(57) ABSTRACT

Paragraph management software with a paragraph authoring workstation, the workstation capable of integrating directly with desktop word processing software to create individual paragraph components, a paragraph server, the server capable of coordinating data flow between virtual objects and responding to requests to perform operations on those objects, the virtual objects including a selection of paragraphs or other document fragments such as charts or graphs, the virtual objects flowing to and from desktop applications, back-office sources, external databases and the like, a paragraph viewer, the said viewer being accessible to the user via an icon appearing on the user's desktop section of his or her computer screen, said viewer giving the user access to any paragraph servers that are available on said user's system, said user having access to any number of virtual publications, virtual documents or virtual paragraphs that are available to the user depending on the user's security privileges, said security privileges including custom encryption devices, said encryption devices allowing an author of proprietary information to charge money for said virtual objects allowing said user to only receive said proprietary information if said user has paid for decryption software, and said author or end user having the ability to access each paragraph independently and to assemble said paragraphs into new, customized documents.

### BACKGROUND OF THE INVENTION

This invention relates generally to the field of computer software, and more particularly to paragraph management software.

Word processing and other processing software systems that work on computers have been designed and available to the public for the last forty years. More recently computers within corporations have been set up to communicate with each other via local area networks or LANs. This allows users to share information from one computer to another. Additionally, the advent of the Internet now lets people access documents from websites anywhere around the world and to have them show up on their individual computers.

Existing technology includes the ability of a person to transfer a document from one place in a computer to another or to transfer a document from one computer to another. However, there has not previously existed a system for quantifying and transferring individual paragraphs from one electronic source to another. Additionally, there has not been a way for an author of a paragraph to encrypt said paragraph and to sell it to an end user, said end user having paid for the author's decryption software. Finally, there has not been a way for people to identify and interpret paragraphs by structure as well as by content.

### SUMMARY OF THE INVENTION

The primary object of the invention is to provide paragraph management software that allows a person to pull paragraphs from a variety of sources and recombine them to form a new document.

Another object of the invention is to provide paragraph management software where a paragraph can be produced by an author and then sold to a user through the Internet or other means of transfer.

Another object of the invention is to provide paragraph management software that allows a person to quickly search a large number of documents to look for similar paragraph structures.

A further object of the invention is to provide paragraph management software that can interact with most existing forms of electronic data storage media and most word processing programs.

Yet another object of the invention is to provide paragraph management software that allows each paragraph to be encrypted so that only someone with the proper decryption software can read and use said paragraph.

Other objects and advantages of the present invention will become apparent from the following descriptions, taken in connection with the accompanying drawings, wherein, by way of illustration and example, an embodiment of the present invention is disclosed.

Paragraph management software comprising: a paragraph authoring workstation, said workstation capable of integrating directly with desktop word processing software to create individual paragraph components; a paragraph server, said server capable of coordinating data flow between virtual objects and responding to requests to perform operations on those objects, said virtual objects including a selection of paragraphs or other document fragments such as charts or graphs, said virtual objects flowing to and from desktop applications, back-office sources, external databases and the like; a paragraph viewer, said viewer being accessible to the user via an icon appearing on the user's desktop section of his or her computer screen, said viewer giving the user access to any paragraph servers that are available on said user's system, said user having access to any number of virtual publications, virtual documents or virtual paragraphs that are available to the user depending on the user's security privileges, said security privileges including custom encryption devices, said encryption devices allowing an author of proprietary information to charge money for said virtual objects allowing said user to only receive said proprietary information if said user has paid for decryption software, and said author or end user having the ability to access each paragraph independently and to assemble said paragraphs into new, customized documents.

The drawings constitute a part of this specification and include exemplary embodiments to the invention, which may be embodied in various forms. It is to be understood that in some instances various aspects of the invention may be shown exaggerated or enlarged to facilitate an understanding of the invention.

### BRIEF DESCRIPTION OF THE DRAWINGS

FIG. 1 is a schematic view of the paragraph server of the present invention

FIG. 2 is a schematic view of the paragraph server connectivity of the present invention.

FIG. 3 is a schematic view of the paragraph server architecture of the present invention

FIG. 4 is a diagram of the paragraph workflow of the present invention

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

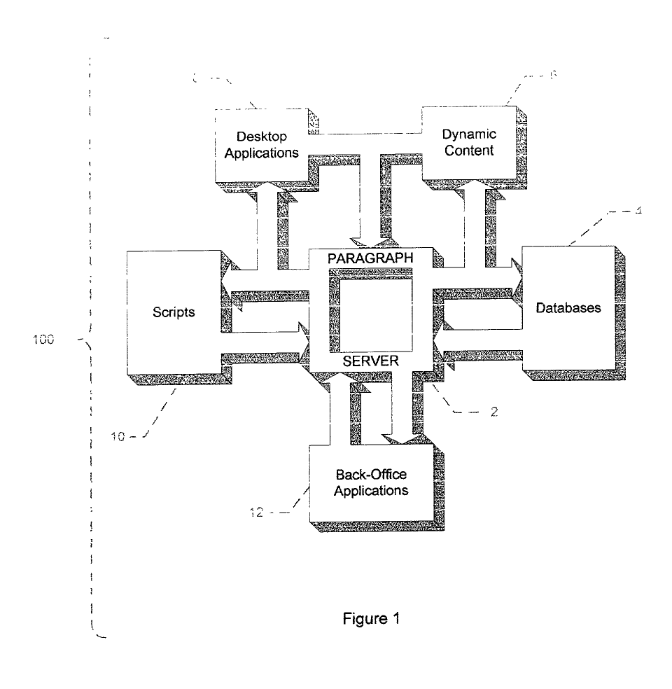

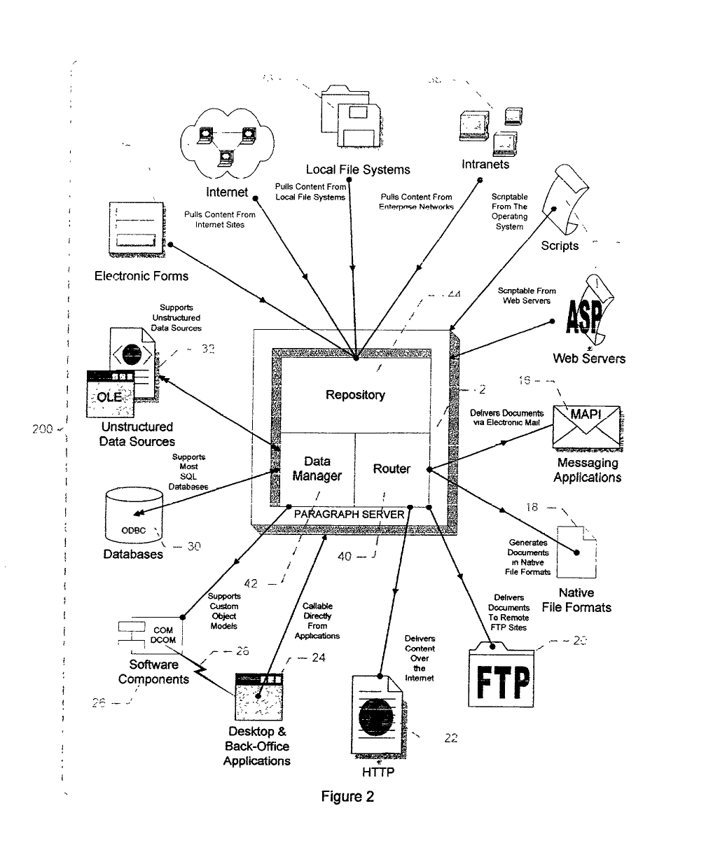

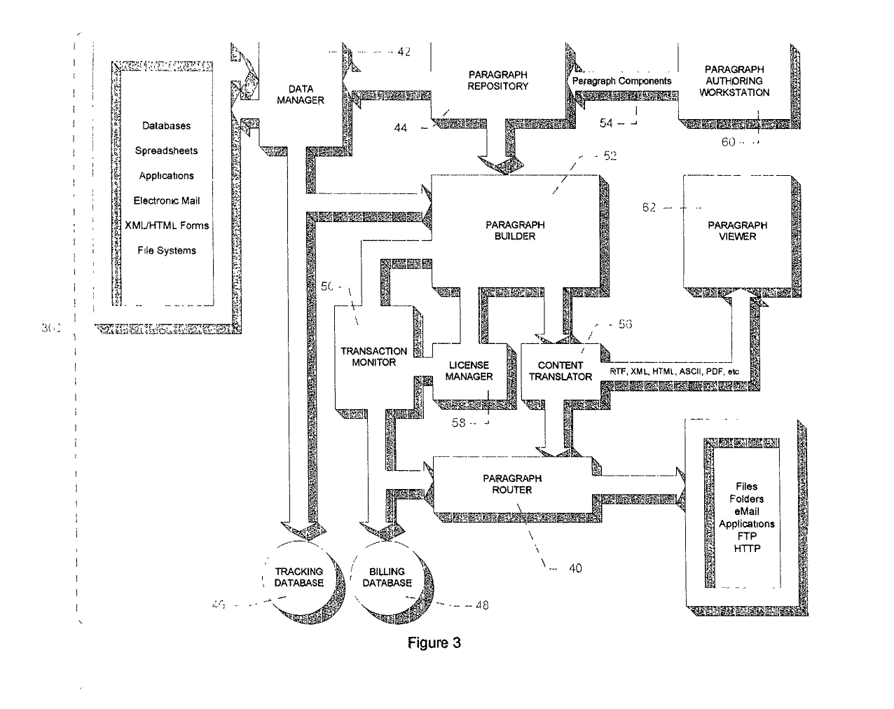

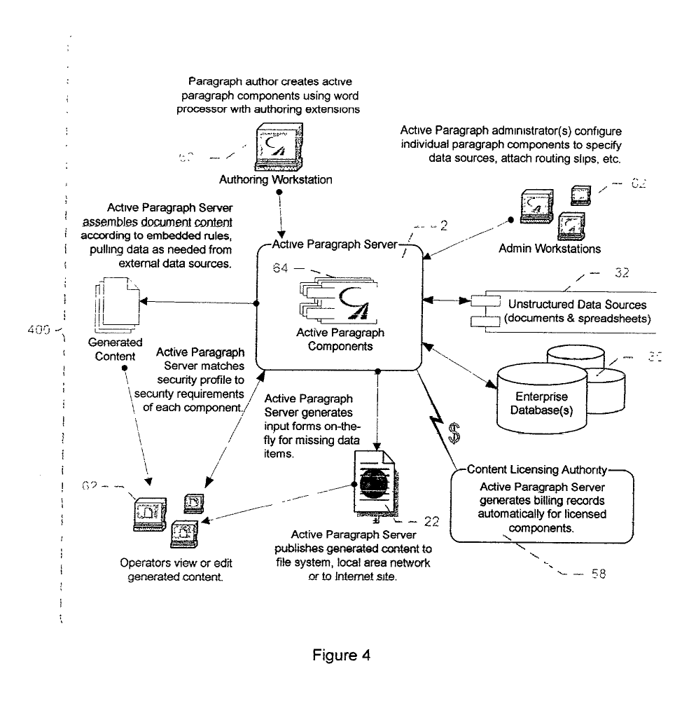

Referring now to FIG. 1 we see a schematic view of the paragraph server and its coordination of data flow of the present invention. The server 2 is set up to receive and give out data to databases 4, dynamic content 6, desktop applications 8, scripts 10 and back-office applications 12. The paragraph server 2 is responsible for coordinating data flow between virtual objects, defined as paragraph elements, and for responding to requests to perform operations on those objects. Data can flow seamlessly to and from back-office and desktop applications as well as external databases. At a more detailed level, the paragraph server acts as a central hub that controls the flow of all information related to the location, validation, construction and distribution of dynamic content. In FIG. 2 wee see a schematic diagram of the paragraph server connectivity 200 of the present invention. The paragraph server 2 is shown at the center of the schematic. Attached to the server 2 are the paragraph repository 44 where data is stored, the paragraph router 40 that shuttles information between the server 2 and the Internet 34, file systems 36 and local area networks 38, and the like, and the data manager 42 that organizes the data that comes into the paragraph server from OLE 32 short for object linking and embedding, ODBC 30 short for open database connectivity and COM/DCOM 26 short for component object model and distributed component object model. FIG. 3 shows paragraph server architecture 300. In this block diagram, one can clearly see the flow of events from inputting data from the data manager 42 and repository 44, to be assembled into usable form by the paragraph builder 52. The content translator 56 formats the information so that it can be read by various protocols such as RTF, XML, HTML, ASCII, PDF and Postscript and the paragraph router 40 that sends the information to a file or electronic mail or the like. After the information is built 52 a transaction can take place through the transaction monitor 50 which then activates a billing function 48 and sends a copy of the bill via router 40. Data can be independently tracked through data tracking function 46. FIG. 4 shows the paragraph workflow 400. The paragraph component author uses the paragraph authoring workstation 60 to create individual paragraph components 64 or virtual document fragments consisting of many paragraph components, and to publish them to the paragraph repository of the paragraph server 2. Paragraph components 64 can be re-configured after publication using the paragraph viewer 62 to specify routing slips, alternate data sources or custom behaviors. The paragraph server 2 assembles the document content according to rules embedded within each paragraph component 64, pulling data as needed from external databases 30 or unstructured data sources 32. During the assembly process, the paragraph server 2 matches the active security profile of the operator or operating system to the specific security requirements of each paragraph component 64 as defined by the author of said component. The paragraph server 2 contacts the appropriate content licensing authority 58 to generate billing records or otherwise secure payment for proprietary content as defined by the paragraph author. The paragraph server 2 may generate data input forms as needed for missing or inconsistent data items. The paragraph server 2 publishes the generated content to the file system, local area network, messaging system or web browser as appropriate, where it can be viewed using the paragraph viewer 62, word processing software or a web browser.

Another advantage afforded by the present software system is the ability to digitally sign and encrypt individual paragraphs. Through this mechanism, a single document may contain content that has been authored by multiple content providers, each with a different digital signature. What this means for the content author is the ability to license expertise in a secure, distributed environment and to receive royalties each time it is used.

A typical application of the present paragraph software invention might be in assembling a legal document such as a Living Will. In this case, boilerplate type language paragraphs can be inserted along with customized paragraph components that can be automatically pulled from other data files relating to asset contents, values and amounts. The completed document may contain statements made by licensed professionals. These statements can be authenticated by a digital signature that confirms that the expert made the statement. When the final document is constructed, each said statement can be encrypted by an encryption service such as VeriSign so that the receiver needs a digital certificate to view its content. If said digital certificate is missing or is otherwise incorrect, the individual statement may be excluded from the document or replaced automatically with different, non-secured content.

The above drawings and descriptions show how the unique paragraph managing software of the present invention can help individuals and companies make better use of the data they store and transfer on a regular basis. Rather than dealing with whole documents, the user can deal with individual paragraphs from a variety of sources to assemble new documents.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. Paragraph management software comprising:
a paragraph authoring workstation;
said workstation capable of integrating directly with desktop word processing software to create individual paragraph components;
a paragraph server;
said server capable of coordinating data flow between virtual objects and responding to requests to perform operations on those objects;
said virtual objects including a selection of paragraphs or other document fragments such as charts or graphs;
said virtual objects flowing to and from desktop applications, back-office sources, external databases and the like;
a paragraph viewer;
said viewer being accessible to the user via an icon appearing on the user's desktop section of his or her computer screen;
said viewer giving the user access to any paragraph servers that are available on said user's system;
said user having access to any number of virtual publications, virtual documents or virtual paragraphs that are available to the user depending on the user's security privileges;
said security privileges including custom encryption devices;
said encryption devices allowing an author of proprietary information to charge money for said virtual objects allowing said user to only receive said proprietary information if said user has paid for decryption software;
and said author or end user having the ability to access each paragraph independently and to assemble said paragraphs into new, customized documents.
